(19) United States
(12) Patent Application Publication
(10) Pub. No.: US 2003/0208348 A1
(43) Pub. Date: Nov. 6, 2003

(54) Method and system for simulation of frequency response effeccts on a transmission line due to coupling to a second electrical network by direct synthesis of nulls

(76) Inventor: Arthur Williams, Smithtown, NY (US)

Correspondence Address: KENYON & KENYON, ONE BROADWAY, NEW YORK, NY, 10004, US

(21) Appl. No.: 10/139,051

(22) Filed: May 2, 2002

(51) Int. Cl. G06F 17/50

(52) U.S. Cl. 703/14

(57) ABSTRACT

The present invention provides a method and system for simulating the effect on the frequency response of a transmission line due to the coupling of a second electrical network to the transmission line. It is observed that signals propagating through the second electrical network are reflected at the end of the second electrical network, thereby propagating back to the point of coupling with the transmission line causing partial cancellations of signals present. Thus, the second network effectively operates as a delay line, with an overall effect of creating nulls of various widths and depths in the frequency response of the transmission line. This second delay-line like network is replaced with a significantly simpler configuration.

### FIELD OF THE INVENTION

The present invention relates to the areas of communications, signal processing and transmission. In particular, the present invention relates to a method and system for directly simulating the frequency response effects on a transmission line due to a coupling with a second external network.

### BACKGROUND INFORMATION

In recent years the diversity of communication systems (digital and analog) has grown significantly as have the demands placed on these systems to provide efficient, reliable, inexpensive and fast communication pathways. For example, the Internet and World-Wide-Web (“WWW”) serve as a focus of communications, between business and personal users. A need for high bandwidth communication services (“broadband”) has become more pronounced. For example, the use of xDSL (“Digital Subscriber Line”) (e.g., ADSL, HDSL and VDSL) technology is a popular option for providing high speed data services. DSL provides a high-speed data link between the telephone company central office and the home or office over ordinary telephone lines without impacting voice service. This is possible because of the significant amount of unused bandwidth available over local loops above the voice spectrum. Using sophisticated modulation schemes data rates as high as 52 Mbps are possible.

However, achieving reliable broadband services over a physical layer is highly dependent upon the frequency response characteristics of the physical medium. Thus, it is often desirable to simulate the frequency response of transmission lines, which serve as a medium for the transmission of electrical signals. For example, DSL utilizes the existing telephone network local loop for multiplexing of high bandwidth communication data services in conjunction with pre-existing voice services. However, the bandwidth capability of a transmission line is often significantly impacted by the existence of bridged taps in the line. A bridged tap is an extraneous short length of an unterminated twisted-pair cable on a local loop (telephone line), usually remaining from a previous configuration and connected in parallel with a functional telephone line.

In designing DSL digital communications systems it is necessary to perform simulations of the effect of bridged taps on the frequency characteristic of the transmission line. For example, in order to test xDSL modems during product development and manufacturing, conventional approaches utilize telephone line simulations. A telephone line simulator approximates the attenuation and phase of a local loop using a finite number of RLC sections as an approximation to a transmission line. A significant problem with conventional approaches to simulation of the effect of bridged taps on the frequency characteristic of the transmission line is that they typically require a significant number of RLC components, due to the attempt to approach a distributed RLC model, which results in higher complexity and cost for the simulations. Thus, it would be desirable to be able to simulate the effect of a secondary network on the frequency characteristic of a transmission line by a simpler and less expensive network.

### BRIEF DESCRIPTION OF THE DRAWINGS

FIG. 1 illustrates the topology of a bridged tap in relation to a telephone line from a central office to a subscriber.

FIG. 2 illustrates a two-port model of a bridged tap utilizing lumped impedance parameters per unit length.

FIG. 3 illustrates a conventional RLC network for simulating a transmission line.

FIG. 4 illustrates a conventional RLC network to simulate the effect of bridged taps in a local loop.

FIG. 5 illustrates the effect of a bridged tap in a local loop utilizing the concept of phase delay.

FIG. 6 illustrates the effect of a bridged tap on the frequency characteristic of a transmission line.

FIG. 7a illustrates a method for simulating the effect of a second electrical network on the frequency characteristic of a transmission line according to one embodiment of the present invention.

FIG. 7b illustrates, in greater detail, a method for simulating the frequency response effect introduced by the coupling of second electrical network to a transmission line according to one embodiment of the present invention.

FIG. 8 illustrates the reduction of complexity achieved by the present invention in the networks required for simulating the effect of a bridged tap on the frequency characteristic of a transmission line according to one embodiment of the present invention.

FIG. 9 illustrates an equivalent circuit for calculating the effect of a bridged tap on the frequency characteristic of a transmission line according to one embodiment of the present invention.

FIG. 10a illustrates an exemplary frequency dependent impedance amplitude characteristic obtained by utilizing the relationship for Z_{IN}.

FIG. 10b illustrates an exemplary frequency dependent impedance phase characteristic obtained by utilizing the relationship for Z_{IN}.

FIG. 11 illustrates an exemplary frequency characteristic for the circuit shown in FIG. 9 by replacing the impedance network by an impedance calculated according to the present invention.

FIG. 12 shows a series resonant circuit for achieving a transfer characteristic associated with the coupling of a transmission line to a second electrical network according to one embodiment of the present invention.

FIG. 13 is a model curve of a null, which may be utilized for determining appropriate RLC values of a series resonant circuit to achieve an equivalent frequency characteristic according to one embodiment of the present invention.

FIG. 14 is a design schematic utilizing values computed in the above example according to one embodiment of the present invention.

FIG. 15 compares the calculated attenuation of the circuit of FIG. 14 to the theoretical attenuation of a 50-foot bridged tap, 24AWG PIC according to one embodiment of the present invention. The calculated results are within 1 dB of the theoretical over the entire frequency range shown.

FIG. 16 illustrates a standard test loop containing a 50-foot bridged tap that is specified by ANSI T1.E1.4/98-043R2 “Very-high-speed Digital Lines” according to one embodiment of the present invention.

FIG. 17 illustrates a composite response of all three building blocks using the circuit of FIG. 14 for the bridged taps is shown in FIG. 17 according to one embodiment of the present invention.

### SUMMARY OF THE INVENTION

The present invention provides a method and system for simulating the effect on the frequency response of a transmission line due to the coupling of a second electrical network to the transmission line. It is observed that signals propagating through the second electrical network are reflected at the end of the second electrical network, thereby propagating back to the point of coupling with the transmission line causing partial cancellations of signals present. Thus, the second network effectively operates as a delay line, with an overall effect of creating nulls of various widths and depths in the frequency response of the transmission line.

According to the present invention, the second electrical network is modeled as a shunt impedance by computing the input impedance of the open-ended (non-terminated) transmission line of particular length. This transmission line is then modeled by an impedance network having identical impedance parameters, yielding the frequency response characteristic of the second electrical network. According to one embodiment, the impedance network is created using series resonant circuits, which allows control of the resonant frequency, bandwidth, and depth of each null through appropriate selection of component values.

Utilizing the method of the present invention, the effect of the second electrical network on the frequency characteristic of the transmission line may modeled with significantly lower complexity (many fewer components) than traditional approaches.

According to one embodiment, the second electrical network is a bridged tap. Thus the present invention may be applied to model the effect of a bridged tap on the frequency response of a transmission line. A coupled network causes attenuation of a desired signal due to phase cancellation effects resulting from composite effects of the signal interfering with phase delayed and attenuated returning signals from the coupled network, resulting in nulls in the overall frequency characteristic. The present invention provides a significantly reduced RLC network for simulating the effect of a coupled network by directly synthesizing the nulls of the frequency characteristic resulting in a much simpler and cost effective method for simulating the effects of a coupled network within an electrical network.

### DETAILED DESCRIPTION

The present invention provides a method and system for simulating the frequency response effect resulting from the coupling of a transmission line with a second network. The frequency response effect of the second network on the transmission line is determined by observing that the second electrical network functions as a delay line, producing interference effects due to reflection of signals back into the transmission line with a phase and attenuation offset. The overall effect on the frequency characteristic of the transmission line is the introduction of nulls in the frequency response. The frequency response of the network due to the coupled electrical network is modeled by determining the input impedance of the second electrical network in a shunt configuration with the transmission line. An RLC model achieving this impedance characteristic is then determined utilizing RLC components.

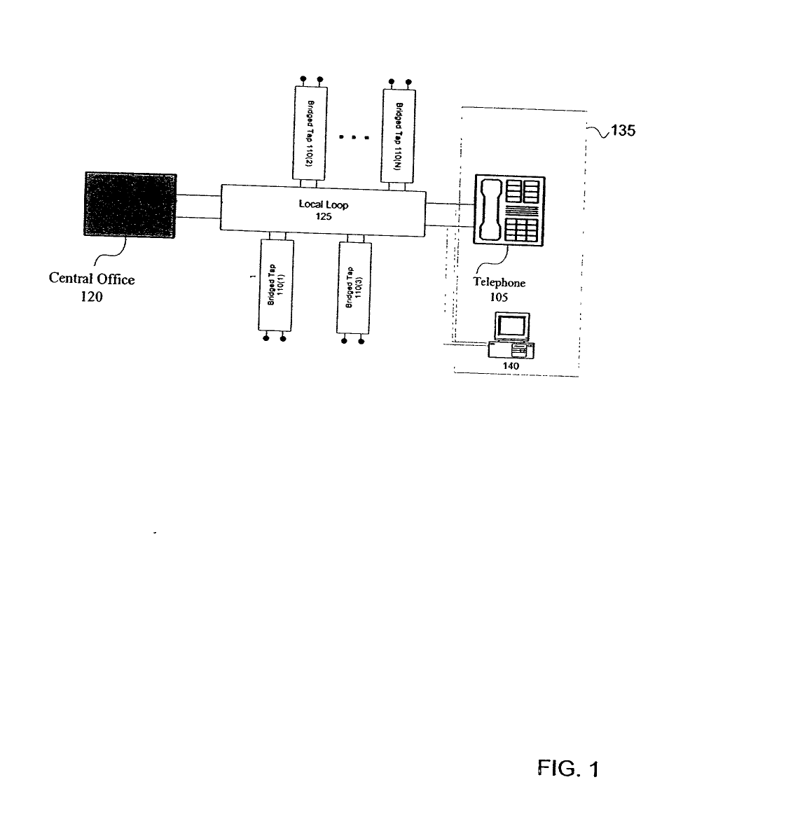

FIG. 1 illustrates the topology of bridged taps in relation to a telephone line from a central office to a subscriber. As shown in FIG. 1, telephone 105 is coupled to central office. End user 135 is coupled to central office 120 via local loop 125. Typically, end user 135 has telephone equipment 105 that is coupled to central office 120 via local loop 125. End user 135 may desire to establish a high bandwidth data connection for personal computer 140 utilizing DSL technology. DSL service is provided as a high bandwidth connection between end user 135 and central office 120 via local loop 125.

Bridged taps 110(1)-110(N) are also coupled to local loop 125. Bridged taps 110(1)-110(N) generate potential for bandwidth degradation due to respective impedances associated with bridged taps 10(1)-10(N).

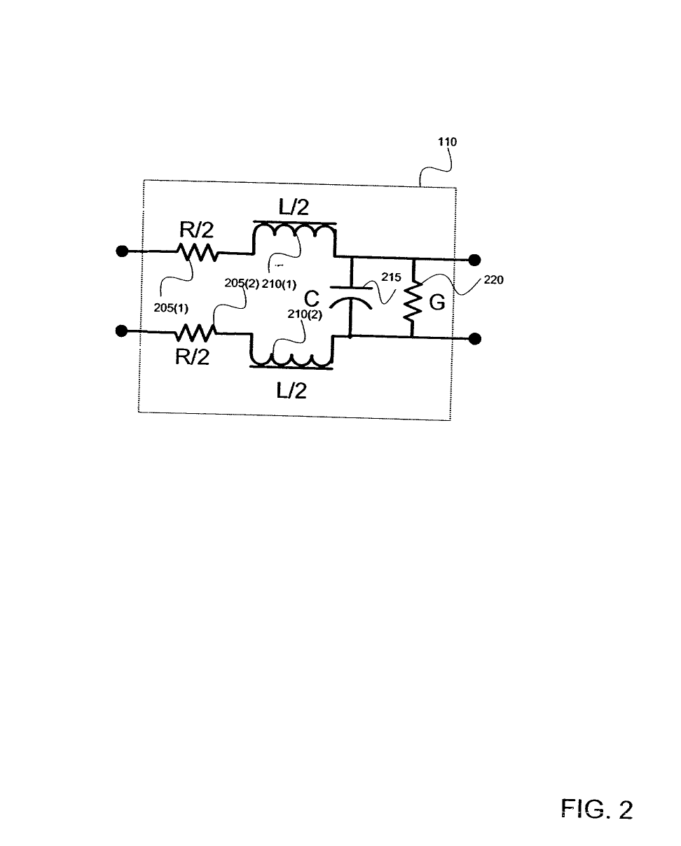

FIG. 2 illustrates a two-port model of a bridged tap utilizing lumped impedance parameters. Thus, bridged tap 110 may be characterized utilizing lumped resistances(R) 205(1)-205(2), lumped inductances (L) 210(1)-210(2), capacitance(C) 215 and conductance (G) 220. Note that FIG. 2 shows a lumped circuit model but this represents a model of bridged tap 110 that would be achieved utilizing distributed parameters (i.e., cascading an infinite number of sections and taking the limit as the size of each section approaches zero). Furthermore, the R, L, C and G parameters may be frequency dependant.

For a lossy transmission line, the associated Kirchoff equations are:

$$\begin{matrix}\frac{\partial v ( x , t )}{\partial x} = - Ri ( x , t ) - L \frac{\partial v ( x , t )}{\partial t} \\ \frac{\partial ( x , t )}{\partial x} = - Gv ( x , t ) - C \frac{\partial v ( x , t )}{\partial t}\end{matrix}$$

Taking the Fourier Transform of the above equations yields:

$$\begin{matrix}\frac{ⅆ V ( x )}{ⅆ x} = - ( R + j ω L ) I ( x ) \\ \frac{ⅆ I ( x )}{ⅆ x} = - ( G + j ω C ) V ( x )\end{matrix}$$

Solving the above equations yields:

$$\frac{{\partial }^{2} V ( x )}{\partial {x}^{2}} - {γ}^{2} V ( x ) = 0$$

where the propagation constant is defined as:

γ=α+jβ=\sqrt{(R+jωL)(G+jωC)}

where α is the attenuation constant (in Nepers) and β is the phase constant (in Radians) per unit length.

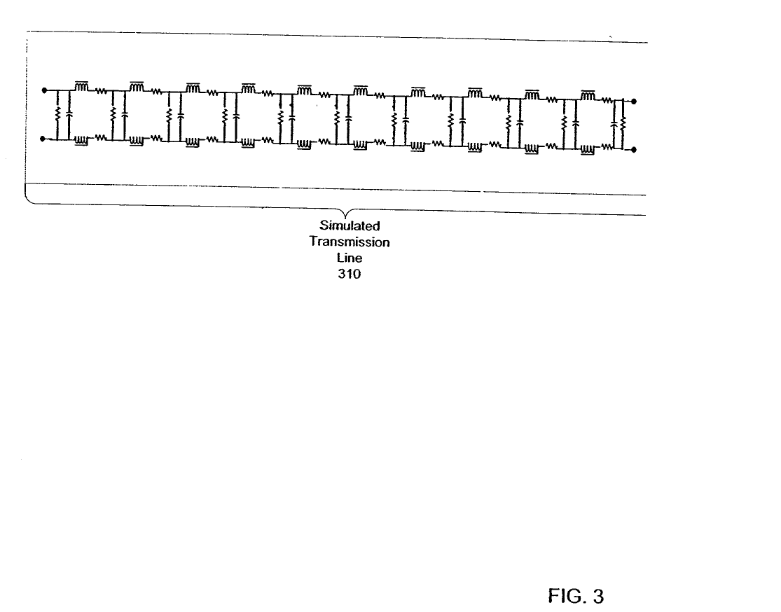

FIG. 3 illustrates a conventional RLC network for simulating a transmission line. Transmission line model 310 includes a finite number of RLC sections as an approximation to a distributed RLC network. In order to test xDSL modems during product development and manufacturing, a telephone line simulator is employed, which approximates the attenuation and phase of a local loop utilizing a model similar to that shown in FIG. 3. Note that the RLC network shown in FIG. 3 may be used for simulating a fixed length of 1000 ft, which is a typical length. If longer lengths are required, multiples of the transmission line model may be coupled in tandem.

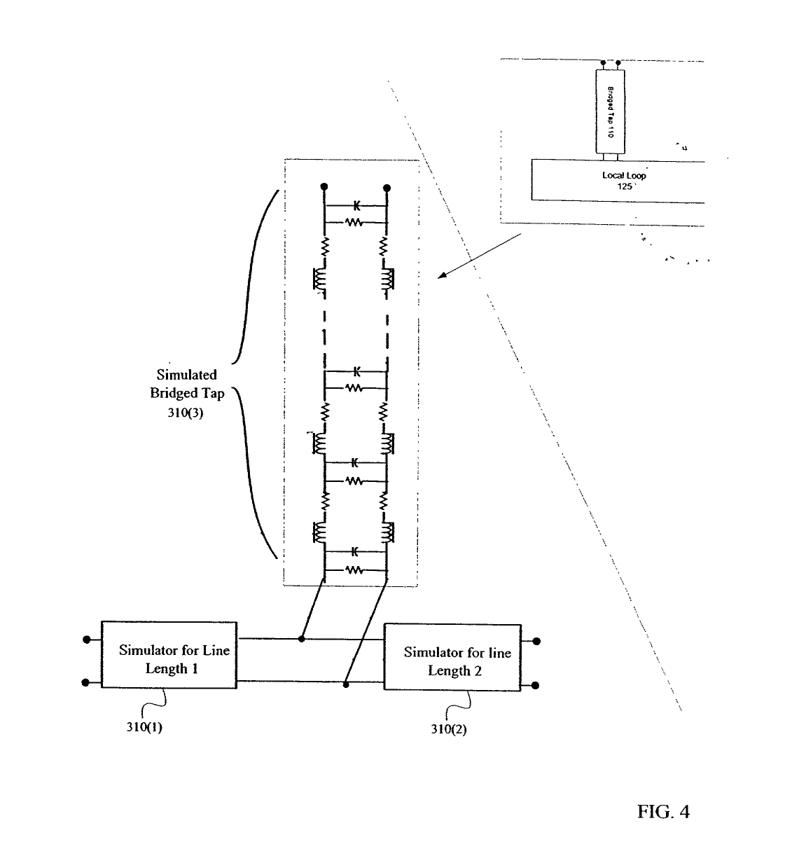

FIG. 4 illustrates a conventional RLC network to simulate the effect of bridged taps in a local loop. As shown in FIG. 4, local loop 125 and a bridged tap 110 are simulated utilizing an RLC model. In particular, the transmission line model 310's architecture is utilized for the bridged tap 310(3) as well as for the lines 310(1)-310(2).

The introduction of a bridged tap (e.g., 310(3)) as shown in FIG. 4 into local loop 125 results in a modified frequency response for the network resulting from frequency dependent attenuation and phase shift within the bridged tap. Rather than focusing upon phase shift, it is more significant to examine phase delay, which is the propagation delay of a sinusoid traveling the length of the bridged tap. Phase delay is defined as: where

$$τ = \frac{β}{ω}$$

where β is the phase shift and ω is the frequency, both in Radians, and phase delay τₚ is in seconds.

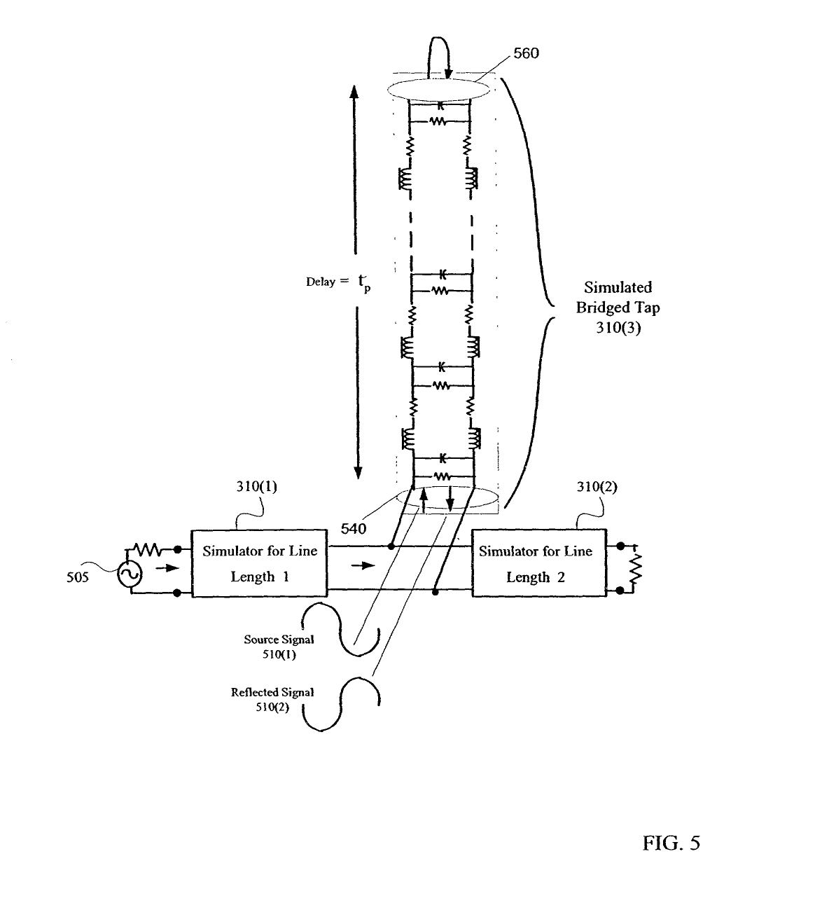

FIG. 5 illustrates the effect of a bridged tap in a local loop utilizing the concept of phase delay. As shown in FIG. 5, sinusoidal source signal 510(1) is applied to input of simulated bridged tap 540 and propagates the length of the bridged tap 310(3) to the unterminated end 560. At unterminated end 560, source signal 510(1) is reflected to produce reflected signal 510(2), which propagates back to the input of the bridged tap 540 resulting in constructive/destructive interference at bridged tap input 540. If the delay of the bridged tap τₚ corresponds to ¼ the period of the sinusoidal signal, then the round trip delay 2τₚ corresponds to ½ the period or 180 degrees. As a result, reflected signal 510(2) is 180 degrees out of phase with source signal 510(1) resulting in partial cancellation of the original signal. The cancellation will occur at all frequencies where τₚ corresponds to odd multiples of ¼ the period of the sinusoidal signal. Note that the cancellation is only partial due to attenuation of the reflected signal 510(2) due to lossy components in the bridged tap.

Based upon the observation noted above that a bridged tap or other unterminated electrical network will function as a delay line introducing interference effects due to reflected signals returning after reflection, the effect on the overall frequency characteristic will be to introduce nulls into the frequency response characteristic due to the cancellation effects.

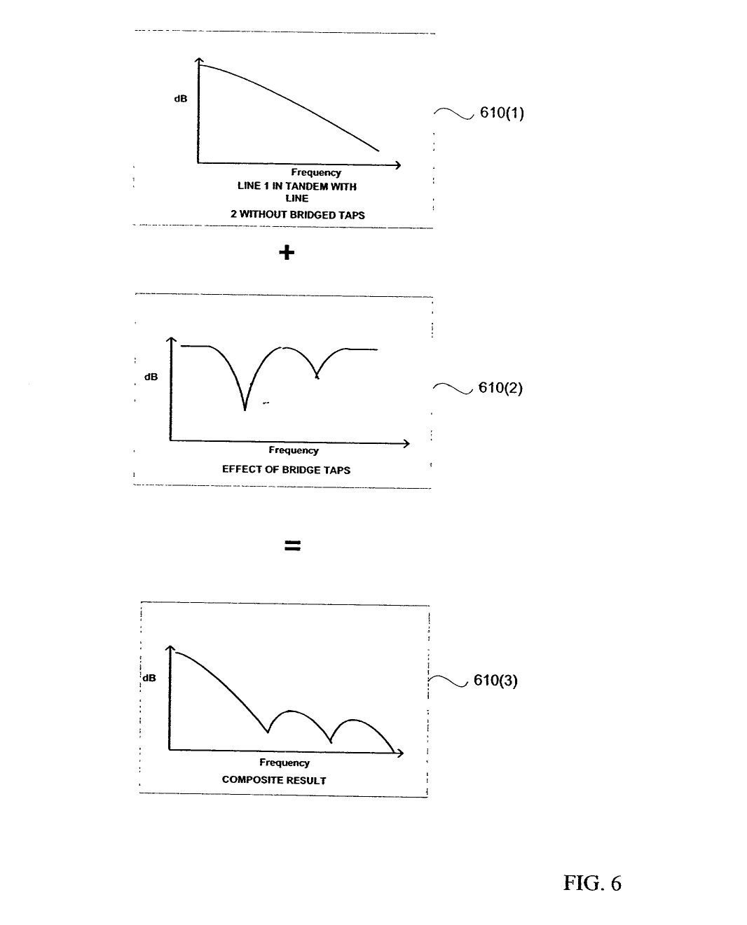

For example, FIG. 6 illustrates the effect of a bridged tap on the frequency characteristic of a transmission line. In particular 610(1) shows the frequency response of a transmission line in the absence of coupling to a bridge tap. 610(2) shows the frequency response due to the bridged tap. 610(3) shows the composite effect of a bridged tap coupled to a transmission line. As the system can be treated as linear and time invariant, the frequency characteristic curves may be multiplied in the frequency domain.

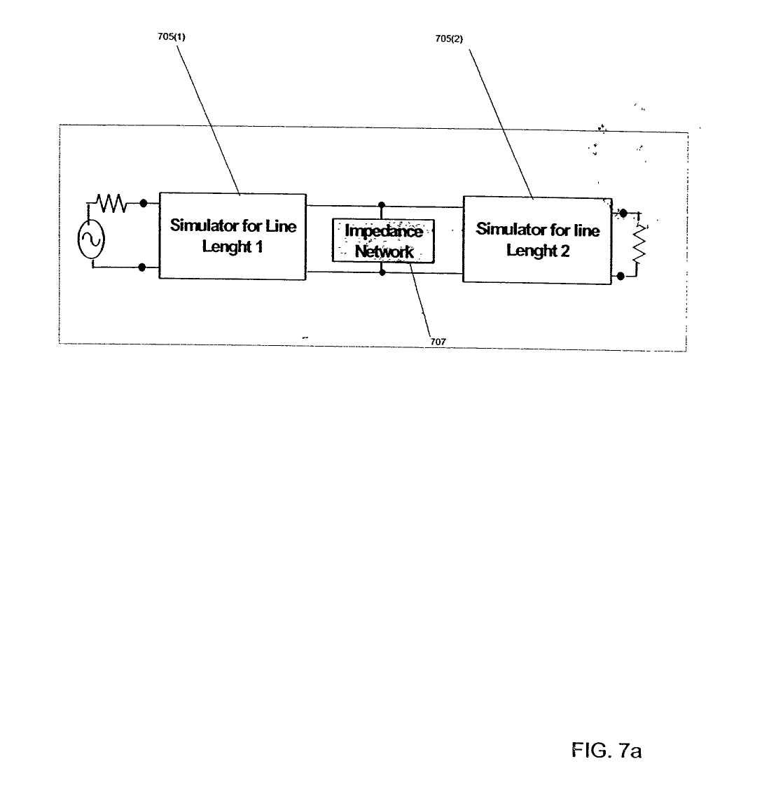

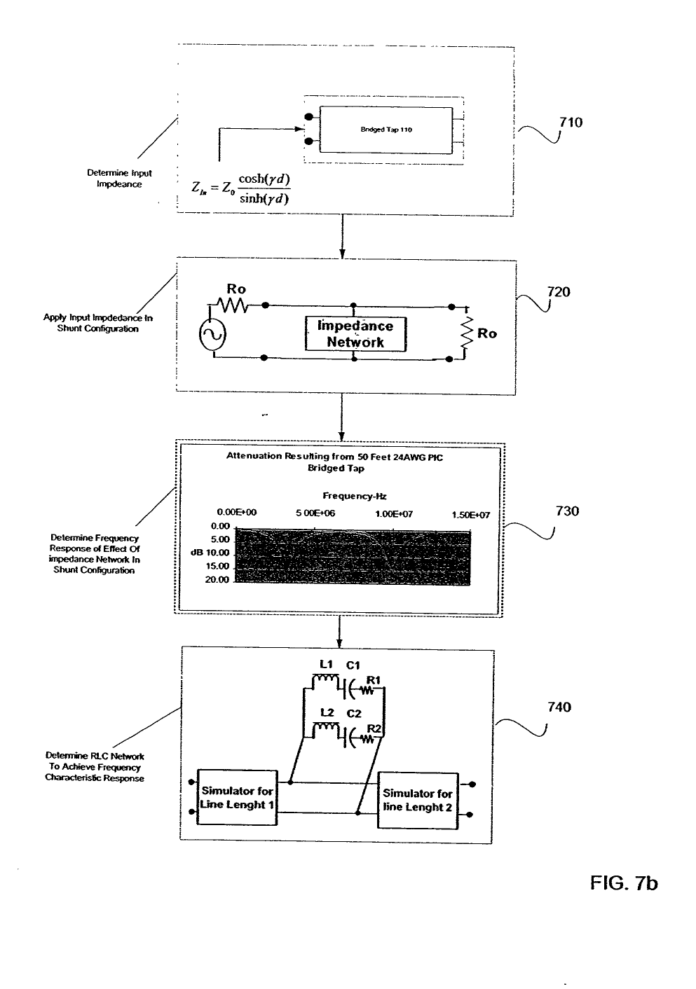

FIG. 7a illustrates a method for simulating the effect of a second electrical network on the frequency characteristic of a transmission line according to one embodiment of the present invention. As the combination of the second electrical network and the transmission line can be treated as a linear time-invariant system, the second electrical network can be modeled as a shunt impedance of an open-ended (not terminated) transmission line of length d. This transmission line may be replaced by impedance network 707 having identical impedance parameters, allowing the precise effect of the second electrical network on the transmission line to be achieved without the complexity of conventional approaches.

FIG. 7b illustrates, in greater detail, a method for simulating the frequency response effect introduced by the coupling of second electrical network to a transmission line according to one embodiment of the present invention. In step 710, an input impedance of the second electrical network is determined. According to one embodiment of the present invention, the input impedance of the second electrical network is determined using transmission line theory by the relationship:

$${Z}_{IN} = {Z}_{0} \frac{cosh ( γ d )}{sinh ( γ d )}$$

where Z₀ is the characteristic impedance of a telephone line (nominally 100 Ω), γ is the propagation constant and d is the line length.

In step 720, the impedance calculated in step 710 is substituted for an impedance network coupled in a shunt configuration with the transmission line to determine the attenuation.

In step 730, the frequency characteristic resulting from the calculated input impedance applied in a shunt configuration to the transmission line in step 720 is determined.

In step 740, a series resonant circuit is determined to achieve the frequency characteristic determined in step 730. According to one embodiment, more than one resonant circuit may be used for this purpose. By controlling the resonant frequency, depth, and bandwidth of each null through appropriate selection of component values, the precise effect of the second electrical network may be achieved, which are the introduction of finite nulls in the overall transfer function. This is achieved at a significantly lower complexity than the approach used in the prior art.

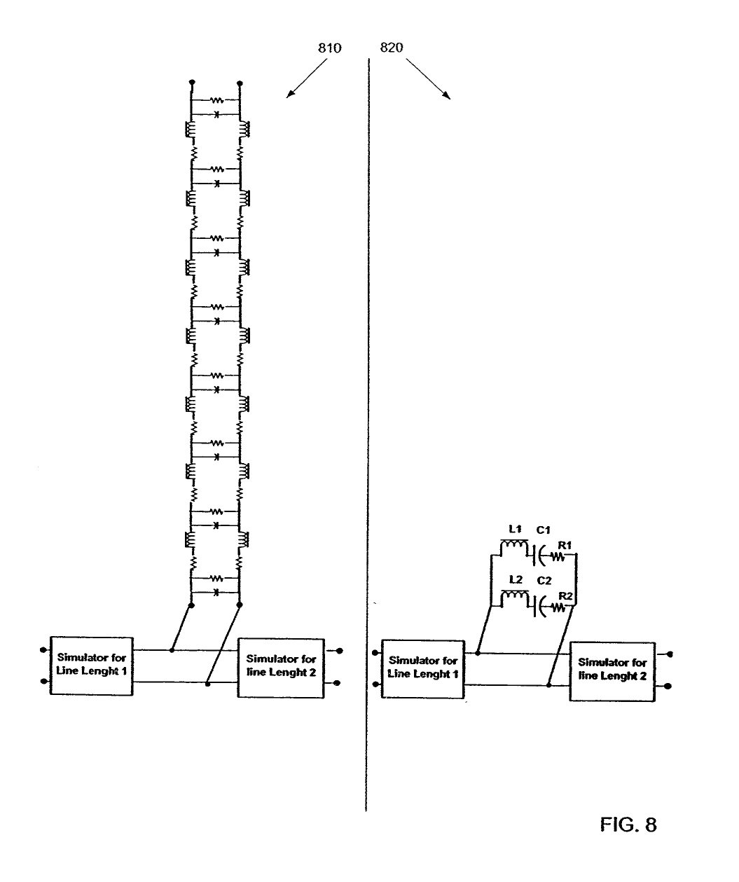

FIG. 8 illustrates the reduction of complexity achieved by the present invention in the networks required for simulating the effect of a bridged tap on the frequency characteristic of a transmission line according to one embodiment of the present invention. In particular, 810 shows a simulation topology required by conventional approaches. In contrast, 820 shows a simulation topology according to the present invention, which utilizes a much simpler network, which requires far fewer discrete circuit components at reduced cost.

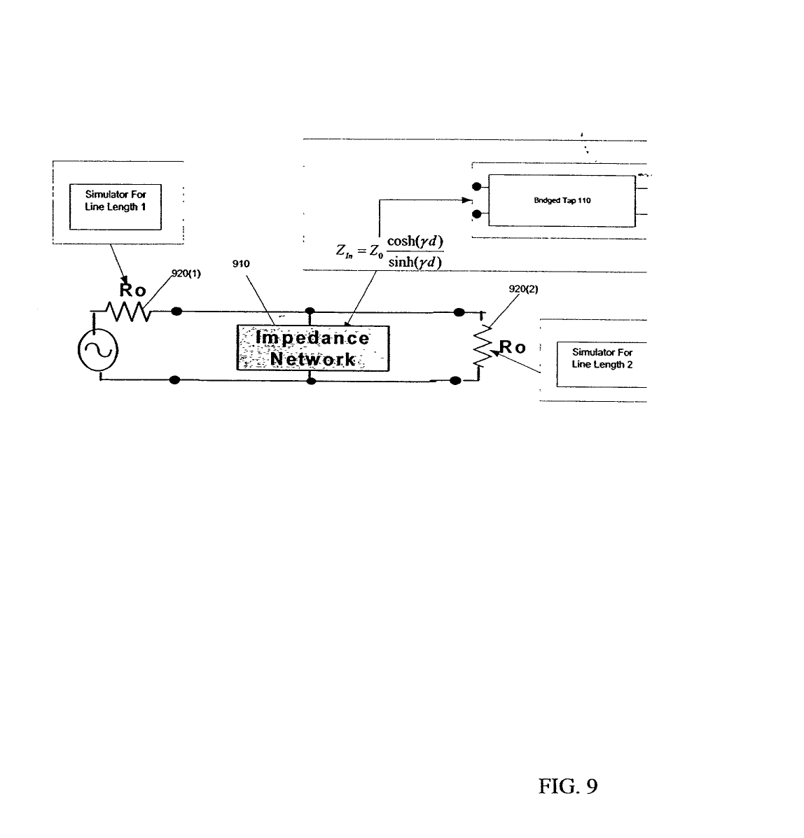

FIG. 9 illustrates an equivalent circuit for calculating the effect of a bridged tap on the frequency characteristic of a transmission line according to one embodiment of the present invention. As shown in FIG. 9, an impedance network 910 is coupled in a shunt configuration with the transmission line. Impedance network 910 utilizes the precise impedance parameters determined for the second electrical network. Furthermore, simulators for the first and second lengths of transmission line are replaced by their respective characteristic impedances 920(1), 920(2).

Thus, as described above, according to one embodiment of the present invention, the input impedance of the second electrical network is determined using transmission line theory by the relationship:

$${Z}_{IN} = {Z}_{0} \frac{cosh ( γ d )}{sinh ( γ d )}$$

where Z₀ is the characteristic impedance of a telephone line (nominally 100 Ω), γ is the propagation constant and d is the line length.

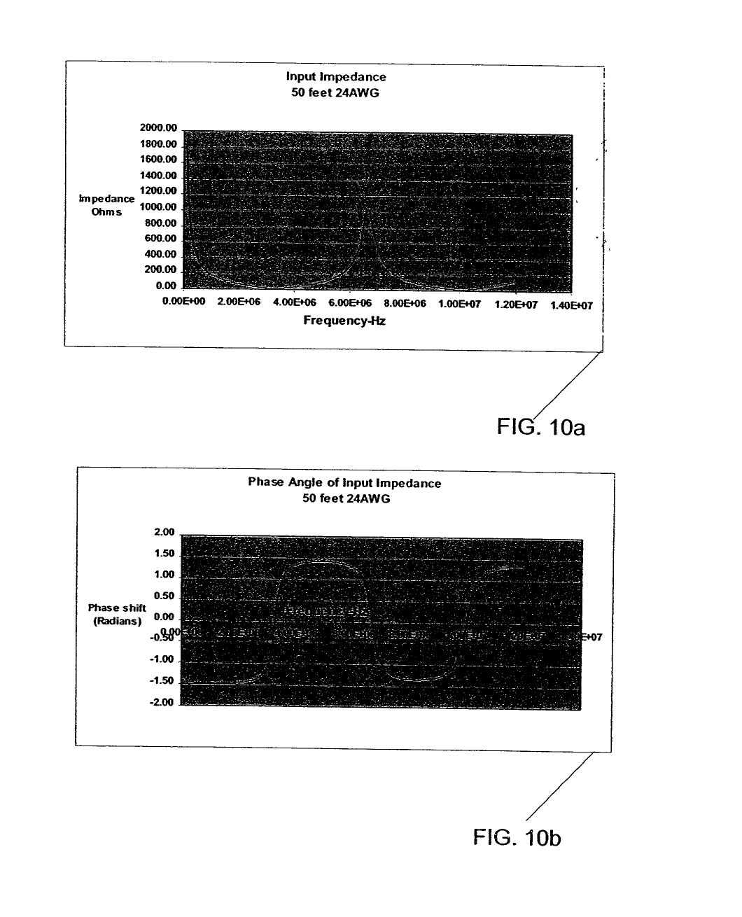

FIG. 10a illustrates an exemplary frequency dependent impedance amplitude characteristic obtained by utilizing the relationship for Z_{IN} described above. Similarly, FIG. 10b illustrates an exemplary frequency dependent impedance phase characteristic obtained by utilizing the relationship for Z_{IN} described above.

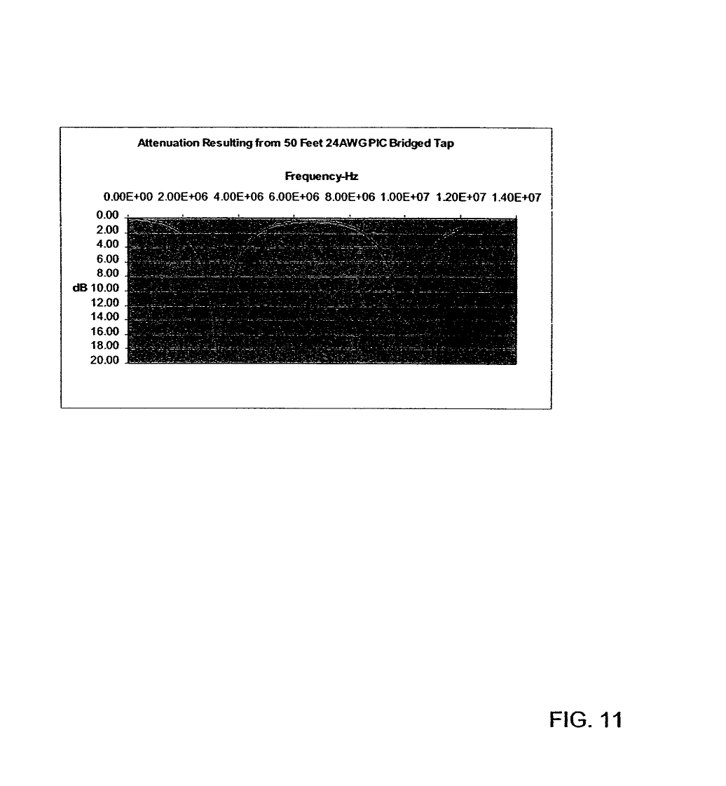

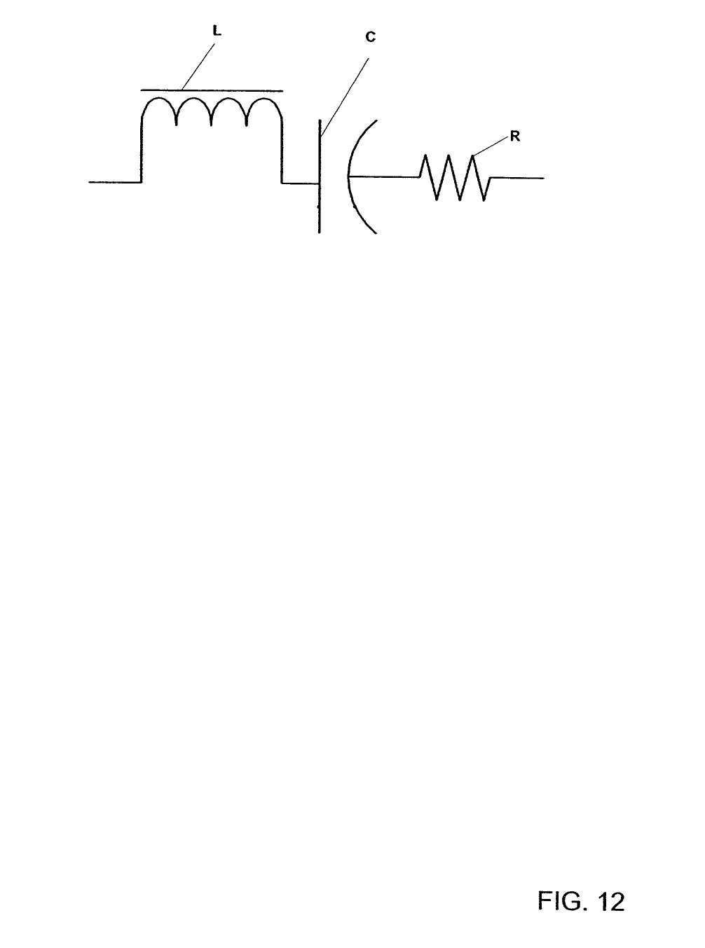

FIG. 11 illustrates an exemplary frequency characteristic for the circuit shown in FIG. 9 by replacing the impedance network by an impedance calculated according to the present invention. As shown in FIG. 11, the frequency characteristic of the transmission line coupled to the second electrical network exhibits attenuation nulls of varying widths and depths at various points.

FIG. 12 shows a series resonant circuit for achieving a single null transfer characteristic associated with the coupling of a transmission line to a second electrical network according to one embodiment of the present invention.

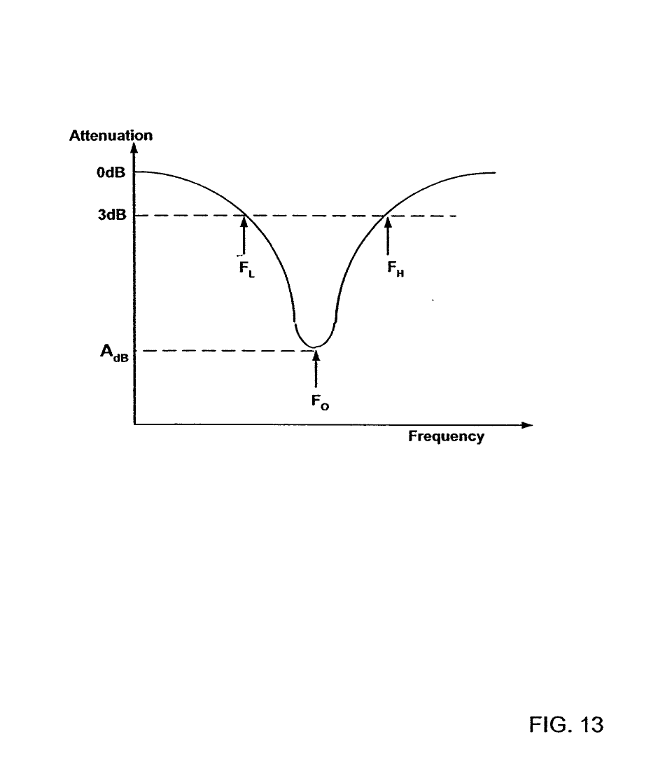

FIG. 13 is a model curve of a null, which may be utilized for determining appropriate RLC values of a series resonant circuit to achieve an equivalent frequency characteristic according to one embodiment of the present invention. In particular, using the curve of FIG. 13 where F_{L} is the lower 3 dB point and F_{U} is the upper 3 dB point the following set of formulas for a single-order band-reject filter having a center frequency F_{O}, selectivity factor Q_{O}, and maximum attenuation A_{dB} may be derived:

Q₀=F₀/(F_{H}−F_{L})

K=10^{(AdB+6)/20}

R=R₀/(K−2)

$$\begin{matrix}L = \frac{Q ( R + {R}_{O} / 2 )}{2 π {F}_{O}} \\ C = \frac{1}{{( 2 π {F}_{O} )}^{2} L}\end{matrix}$$

An exemplary application of the present invention to approximate the attenuation curve shown in FIG. 11 is illustrated below.

The lower null has the following parameters:

F₀=3.3 MHz F_{L}=2.2 MHz F_{H}=4.5 MHz A_{dB}=18.6 dB

The following parameters are calculated:

Q₀=1.4348

K=16.98

R=6.676 where R₀=100 Ω

L=3.922 uH

C=593.1 pF

For the upper null:

F₀=10.0 MHz F_{L}=8.8 MHz F_{H}=11.3 MHz A_{dB}=14.4 dB

The following parameters; are calculated for the upper null:

Q₀=4.00

K=10.47

R=11.8

L=3.934 uH

C=64.38 pF

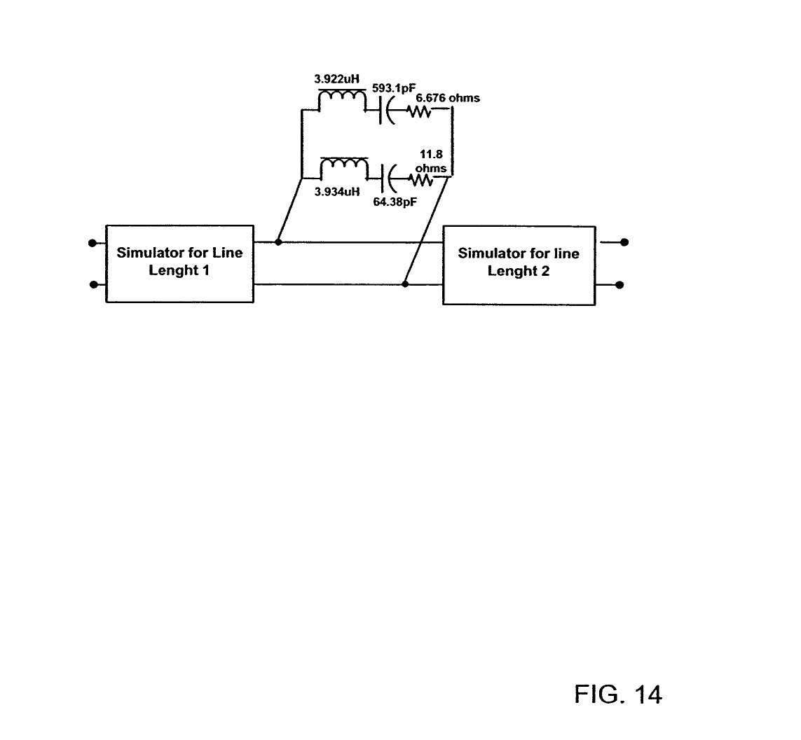

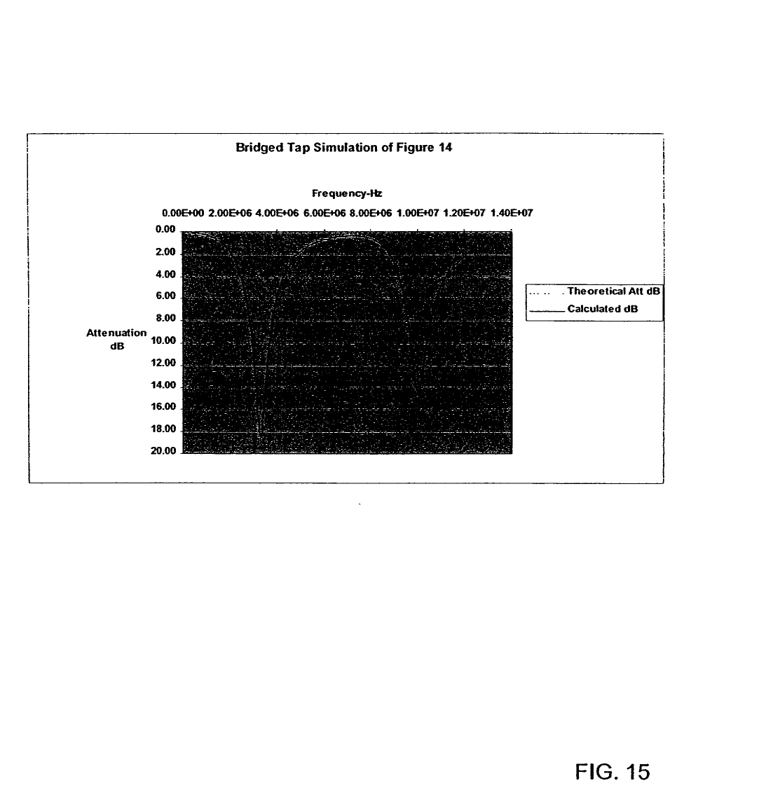

FIG. 14 is a design schematic utilizing values computed in the above example according to one embodiment of the present invention.

FIG. 15 compares the calculated attenuation of the circuit of FIG. 14 to the theoretical attenuation of a 50-foot bridged tap, 24AWG PIC according to one embodiment of the present invention. The calculated results are within 1 dB of the theoretical over the entire frequency range shown.

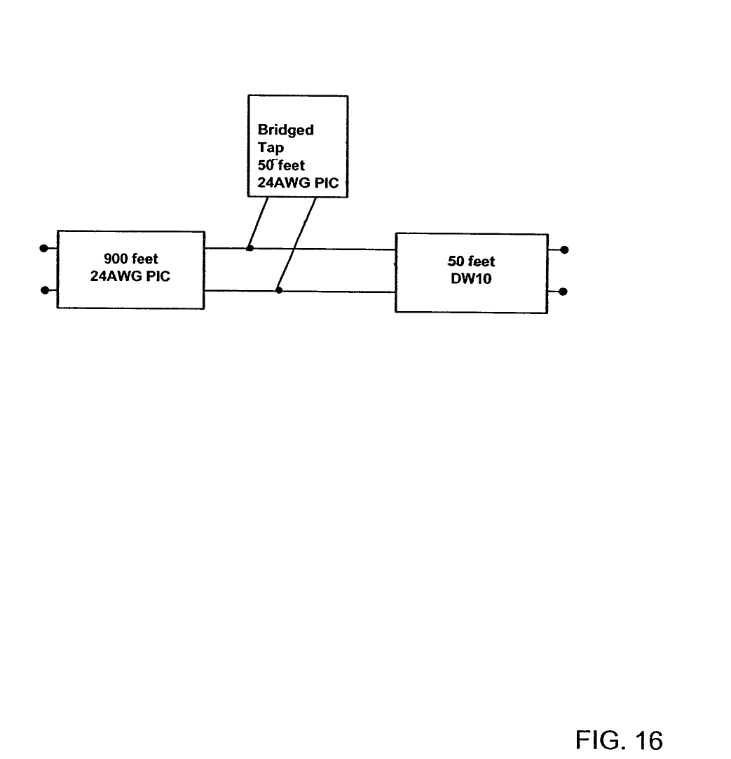

FIG. 16 illustrates a standard test loop containing a 50-foot bridged tap that is specified by ANSI T1.E1.E1.4/98-043R2 “Very-high-speed Digital Lines” according to one embodiment of the present invention.

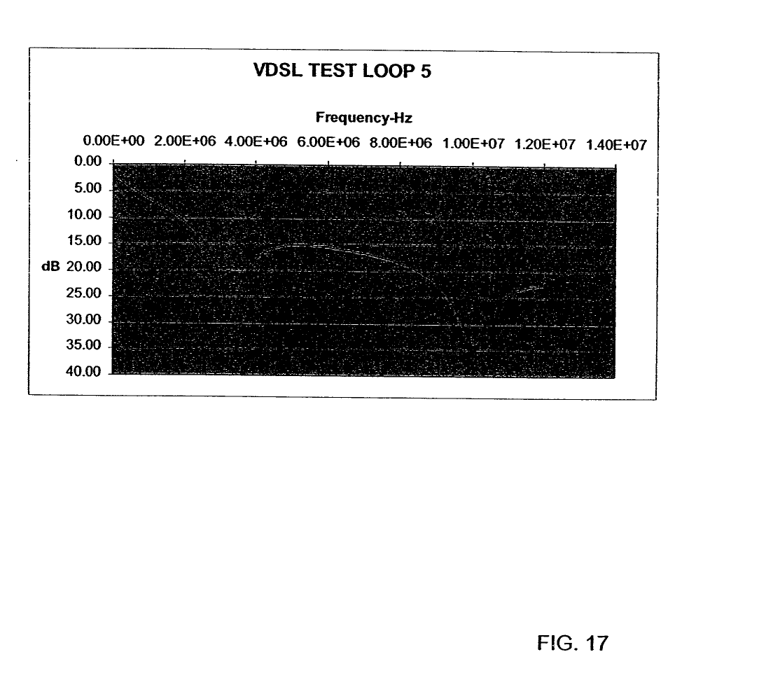

FIG. 17 illustrates a composite response of all three building blocks using the circuit of FIG. 14 for the bridged taps according to one embodiment of the present invention.

What is claimed is:

1. A method for simulating the effect of a terminated transmission line coupled to an unterminated transmission line at an intermediate point comprising:
(a) determining an input impedance of the unterminated transmission line;
(b) determining a characteristic impedance of the transmission line at the intermediate point;
(c) determining a frequency response of the unterminated transmission line coupled to the transmission line in a shunt configuration as a function of the input impedance of the unterminated transmission line and the characteristic impedance of the transmission line;
(d) determining a circuit having the frequency response approximating the frequency response in step (c).

2. The method according to claim 1, wherein the circuit is a series resonant circuit.

3. The method according to claim 1, wherein the circuit is an array of parallel series resonant circuits.

4. The method according to claim 2, wherein the series resonant circuit includes at least one of a resistive component, a capacitive component and an inductive component.

5. The method according to claim 1, wherein the unterminated transmission line is a bridged tap.

6. The method according to claim 1, wherein the input impedance of the unterminated transmission line is determined according to the relationship:
$${Z}_{IN} = {Z}_{0} \cdot \frac{cosh ( γ d )}{sinh ( γ d )}$$
where γ=α+jβ=\sqrt{(R+jωL)(G+jωC)} where d corresponds to a length of the secondary network, R corresponds to a resistance per unit length of the secondary network, L corresponds to an inductance per unit length of the secondary network, C corresponds to a capacitance per unit length of the secondary network, G corresponds to a conductance per unit length of the secondary network, α is an attenuation constant in nepers and β is a phase constant in radians per unit length.

7. The method according to claim 1, wherein the characteristic impedance of the transmission line includes information representing the impedance of the transmission line bi-directionally.

8. The method according to claim 7, wherein the frequency response in step (c) is determined as a function of the information representing the impedance of the transmission line bi-directionally.

9. A system for simulating the effect of an unterminated transmission line coupled to a transmission line at an intermediate point comprising: a central processing unit (“CPU”), wherein the CPU is adapted to:
(a) receive as input a resistance per unit length of an unterminated transmission line parameter (R), a capacitance per unit length of an unterminated transmission line parameter (C), an inductance per unit length of an unterminated transmission line parameter (L) and a conductance per unit length of an unterminated transmission line parameter (G), a characteristic impedance of a transmission line parameter (Z₀) and a length parameter (d);
(b) determine an input impedance of the unterminated transmission line as a function C, R, L, G, Z₀ and d;
(c) determining a frequency response of the unterminated transmission line coupled to the transmission line in a shunt configuration as a function of the input impedance of the unterminated transmission line and the characteristic impedance of the transmission line;
(d) determining a circuit having the frequency response approximating the frequency response in step (c).

10. A method for determining a circuit having a specified frequency response comprising the steps of:
(a) receiving a lower 3_{dB} point parameter (F_{L}) an upper 3_{dB} point (F_{H}), a center frequency F₀ maximum attenuation parameter (A_{dB});
(b) determining a selectivity factor (Q₀) and a second parameter (K);
(c) determining a resistance parameter (R), an inductance parameter (L) and a capacitance parameter (C) as a function of F_{L}, F_{H}, A_{dB}, Q₀ and K.

11. The method according to claim 10, wherein Q₀ is determined according to the relationship:
$${Q}_{0} = \frac{F}{( {F}_{H} - {F}_{L} )} .$$

12. The method according to claim 10, wherein K is determined according to the relationship: K=10^{(AdB+6)/20}.

13. The method according to claim 10, wherein R, L and C are determined according to the relationships:
R=R₀(K−2)
$$\begin{matrix}L = \frac{Q ( R + {R}_{O} / 2 )}{2 π {F}_{O}} \\ C = \frac{1}{{( 2 π {F}_{O} )}^{2} L}\end{matrix}$$
